(19) United States
(12) Patent Application Publication
(10) Pub. No.: US 2014/0061524 A1
(43) Pub. Date: Mar. 6, 2014

(54) Valve With At Least Two Active Positions

(71) Applicant: David Ying Chi Hong, Causeway Bay (HK)

(72) Inventor: David Ying Chi Hong, Causeway Bay (HK)

(21) Appl. No.: 13/603,949

(22) Filed: Sep. 5, 2012

(51) Int. Cl. F16K 3/02

(52) U.S. Cl. CPC F16K 3/02
USPC 251/326

(57) ABSTRACT

A valve with at least two active positions is disclosed. When set in a first position, the valve can be connected to a first channel. While set in a second position, the valve can be connected to a second channel. The valve constitutes a part of a structure of a compressor, preferably a compressor in a tire repair kit. The tire repair kit also includes a cassette with a sealing mass. The valve serves as a rotary valve, which, once set in the first position, forms a channel through which compressed air flows to an outlet. Once set in the second position, the rotary valve forms the other channel through which compressed air flows to the cassette with a sealing mass. By using the rotary valve, the compressor is useful not only for connecting to a punctured tire requiring repair, but also for other purposes.

### FIELD OF THE INVENTION

The utility model relates to a valve with at least two active positions. When set at the first position, the valve can be connected to a first channel; while set at the second position, the valve can be connected to a second channel, in which, the valve constitutes a part of structure with a compression plant, preferably, a compression plant in a tyre repair kit. The tyre repair kit also comprises at least a cassette with a sealing mass; The valve, serving as a rotary valve, once set at the first position, forms a channel through which compressed air flows to an outlet, and once set at the second position, forms the other channel through which compressed air flows to the cassette with a sealing mass.

### BACKGROUND OF THE INVENTION

A spare tire has been used for a few decades. However, in recent years, a car and other vehicles usually are, no longer equipped with a spare tire, but instead equipped with a small compression plant and a small cassette with a sealing mass, which are known as a tyre repair kit, cheaper and lighter than a spare tire, which is environment friendly since less weight leads to lower fuel consumption. Also, the baggage space of a car is available for storing more things. Commonly, the baggage space of a car is equipped with an integrated unit comprising a compression plant and a cassette with a sealing mass. After being started, the compression plant can only be connected with the valve on a vehicle wheel, in this way, the sealing mass is firstly pumped into the tyre. When the cassette is empty, compressed air from the compression plant automatically and directly enters into the tyre, thus ensuring the tyre inflated properly.

From GB2452137 A, we can known that a tyre repair kit has two compressed air outlets; wherein, one outlet, connected to the cassette with a sealing mass, needs revolving on the valve of a tyre before the sealing mass is pumped into a punctured tyre; while the other outlet is used as a compressed air outlet for different pumping-in operations. When used for connecting an outlet through which the sealing mass is let to a tyre, the other outlet, after connected with the valve of a tyre, is provided with an electronic switch which only permits pumping out the sealing mass. In addition, a second electronic switch can be operated to pump compressed air out of the second outlet. This is an improved scheme in adoption of an electric wire. The electric wire, threaded out of the outer casing of the tyre repair kit, is installed on the valve of the tyre by a hose and is equipped with a sensitive electronic switch. In spite of as an advanced scheme, the scheme also has a disadvantage because the electric wire or the electronic switch may be damaged during storage or use.

### SUMMARY OF THE INVENTION

The invention aims at finding out a scheme more suitable than the prior art for a conventional compression plant, available for a more common application. Also, the tyre repair kit can be used immediately. In the new scheme, the tyre repair kit, provided with a switch between at least two outlets, is unnecessary to be provided with an electronic switch, an electric wire or a sensor, convenient for use.

As mentioned above, the invention relates to a valve with at least two active positions, which serves as a rotary valve. When the valve is set at the first position, a channel comes into being, through which compressed air flows to the outlet; when the valve is set at the second position, the other channel comes into being, through which compressed air flows to the outlet. By using the rotary valve, the compression plant in the tyre repair kit is not only used for connecting to a punctured tyre requiring for repair, but also for other purposes. For instance, the compression plant can be used occasionally for measuring tire pressure in automobile, pushcart or bicycle wheels. The compression plant also can be used for checking an airbed, a swim ring and a rubber dinghy concerning their inflation. In the invention, the function can be realized by a valve. By adoption of such a valve, a prepackaged tyre repair kit available at any time can be placed in an automobile baggage space (for example). In addition, the valve can be used for above-mentioned purposes, free from influencing readiness of the tyre repair kit.

The invention also provides a particularly preferential transformed valve with at least two active positions, which is provided with a cylindrical valve body. On the cylindrical surface of the valve body is provided with a first ring groove which is not only communicated with at least a channel extending lengthways along the cylindrical valve body, but also communicated with the outlet to compressed air or the cassette with a sealing mass; the valve is also provided with a valve casing matched with the valve body; the bottom along the inner wall of the valve casing is provided with two valve casing channels; either of the valve casing channels is communicated with the valve body channel; the valve casing is also provided with a sealing mass gasket groove simultaneously enclosing the two valve casing channels; in the seal gasket groove is provided with a two-hole seal gasket matched with the seal gasket groove; at least a part of the two-hole seal gasket is exposed out of the seal gasket groove; the two-hole seal gasket preferentially is shaped like “8”. The valve, simple and solid in structure, is made from plastics or metals concerning specific part. Irrespective of a little dust in compressed air, the valve has scarcely any disadvantage in terms of operation, which is attributed to the simple and solid design.

The valve is so simple and easy to operate that risk of accidentally pumping the sealing mass out of the outlet is very low when the valve is used for above-mentioned purposes. In addition, compared with the existing technical scheme, this tyre repair kit is much cheaper. The valve in the prior art is provided with a switch and connected to the end of a hose so as prevent a sealing mass from pumping out by mistake. However, neither the switch nor the connecting lead directly extending to the end of the hose is absolutely reliable. A defective switch may result in failure of the sealing mass pumped into a tyre. Furthermore, the valve body is provided with an all-in-one two-hole seal gasket, which improves the valve reliability, reduces assembly procedure, and further lowers production cost. The scheme mentioned in the invention is available for realization of an operational scheme, which is purely mechanical, solid and simple.

The invention provides a preferential transformed valve with at least two active positions. The valve can be manually revolved by an angle more than 45 degrees, preferably by an angle of 90 degrees or 180 degrees. However, such a large-angle rotation is basically unnecessary. Anyway, it is advantageous to minimize the risk of pumping compressed air into needless channels. As the valve revolves by a large angle, such possibility is reduced as compressed air is pumped into the cassette resulted from unexpected rotation of the valve body (thus pumping out the sealing mass by mistake). Therefore, the safety is enhanced. Generally, manual revolving of the valve is subject to an influence from a handle, which can be arranged on or in the outside surface of the tyre repair kit.

Another embodiment of the invention provides a scheme, in which, the valve is subject to an automatically mechanical rotation by an angle more than 45 degrees, preferably by an angle of 90 degrees or 180 degrees. An actual switch or a structural element connected to the actual switch is revolved by staring (for instance) an electronic switch or an air driver.

The invention provides a preferential transformed valve with at least two active positions. The cylindrical valve body can be provided with two second ring grooves for the sealing rings; each of the sealing rings sticks on the internal cylindrical surface of the valve casing. Basically, both the ring grooves are used for the sealing rings. Each sealing ring is respectively positioned in each of the second ring grooves above and below the lateral side of the aforementioned first ring groove. The first ring groove forms a channel for compressed air from the compression plant.

### BRIEF DESCRIPTION OF THE DRAWINGS

Brief description of the invention is made by reference to the accompanying drawings, in which:

FIG. 1 shows the integrated unit equipped with a compression plant and a cassette with a sealing mass.

FIG. 2 shows the sectional view of the valve body.

FIG. 3 shows the three-dimensional schematic diagram of the valve body.

FIG. 4 shows the explode view of the valve with an all-in-one two-hole seal gasket.

FIG. 5 shows the front view of the valve casing with an all-in-one two-hole seal gasket.

FIG. 6 shows the lateral view of the valve casing with an all-in-one two-hole seal gasket.

### DETAILED DESCRIPTION OF THE PREFERRED EMBODIMENT

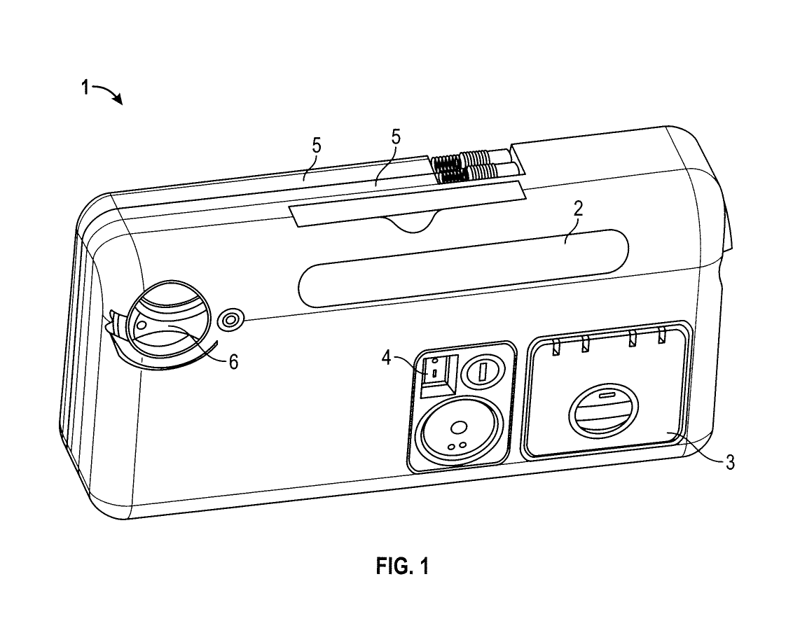

FIG. 1 shows an embodiment related to the integrated unit (equipped with an invisible compression plant and a cassette 2 with a sealing mass) or the tyre repair kit 1. The electric compression plant, whose cover 3 has a connecting lead in the rear, is provided with a socket connected to 12V DC. The compression plant is started by pressing a button 4. When a rotary button 6 is set at a correct position, air is pumped out by either of the hoses 5. In the embodiment, the label points at the pattern of the pump by revolving the button.

In the second possible embodiment, when the rotary button 6 is revolved at the position, pointing at a punctured tyre pattern, the sealing mass is pumped into the punctured tyre before air enters into it. The pump acts by the second one of both the hoses 5. After the sealing mass is pumped in, the integrated unit 1 is adjusted, allowing air passing through the cassette 2 with a sealing mass. In other embodiments, the rotary button 6 maybe needs setting at the pump position. In addition, the integrated unit is also equipped with a pressure gage.

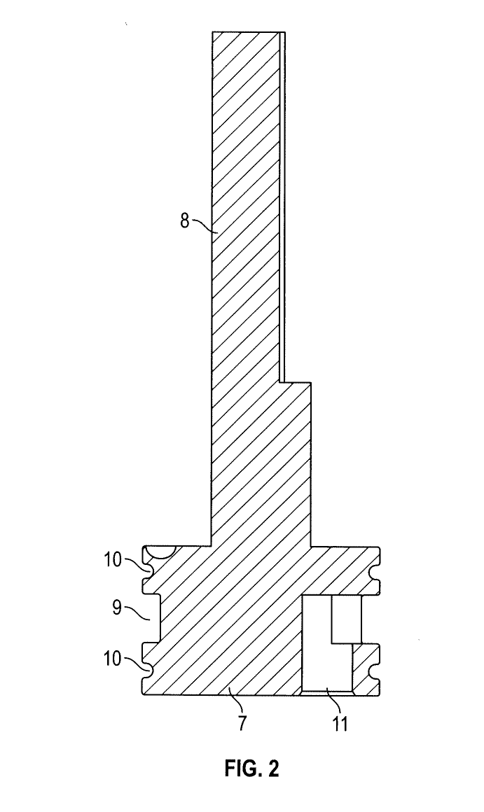

FIG. 2 shows the valve body 7 mentioned in the invention. The valve body 7 is connected with a control unit 8. The control unit 8 is provided with a rotary button 6 (not displayed here but displayed in FIG. 1). The cylindrical valve body 7 is provided with a first ring groove 9 used for the compressed air channel. In addition, the cylindrical part of the valve body is also provided with two second ring grooved 10 which are used for undisplayed sealing mass. In addition, FIG. 2 also shows a valve body channel 11 along the axial direction of the valve body 7. The valve body channel 11 is positioned at the lateral side of the cylindrical valve body, in this way, the first ring groove 9 gets in touch with the valve body channel 11. The valve body channel 11 is provided with an outlet positioned on the bottom end face of the valve body 7. Compressed air is led to a correct discharge outlet through the first ring groove 9 and the valve body channel 11.

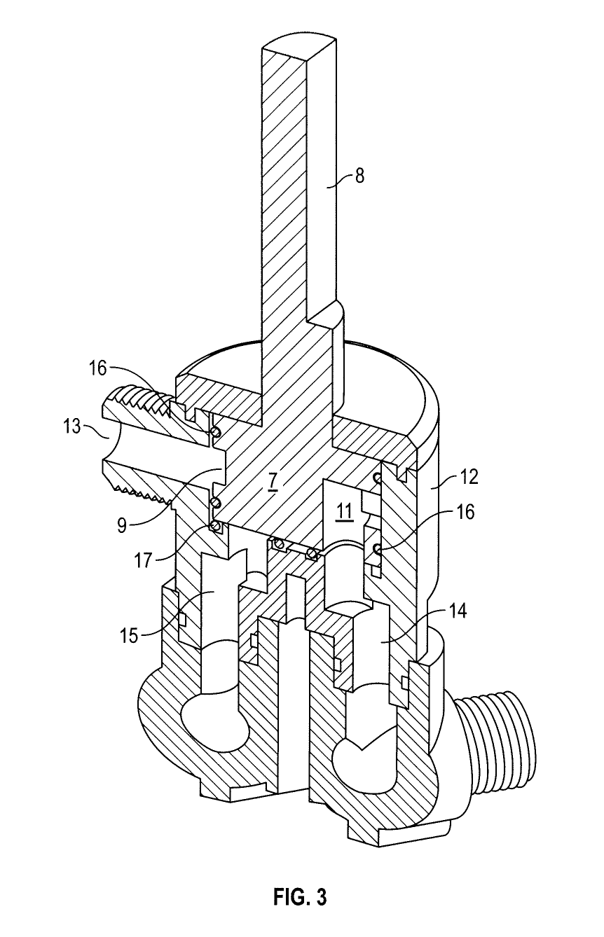

In FIG. 3, the valve body 7 is installed on the valve casing 12. Compressed air is led to the first ring groove 9 through an inlet 13, and is further led to a discharge outlet 14 through the valve body channel 11. The discharge outlet 14/15 can be selected by revolving the valve body 7/the control unit 8. Also, FIG. 3 shows the aforementioned sealing rings 16, and shows the two-hole seal gasket 17 from the bottom along the inner wall of the valve casing 12.

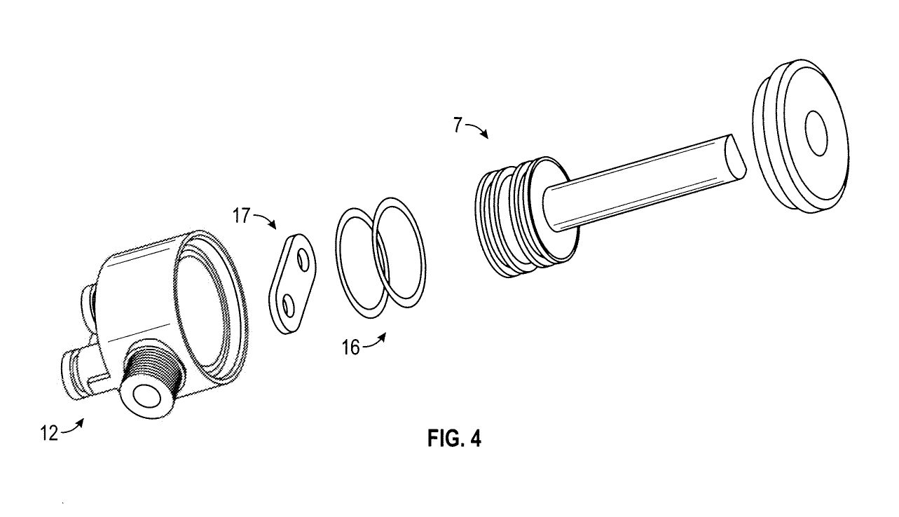

FIG. 4 shows the explode view of the valve with an all-in-one two-hole seal gasket, which clearly shows the shape of the two-hole seal gasket 17 and positional relation between the valve casing 12 and the valve body 7.

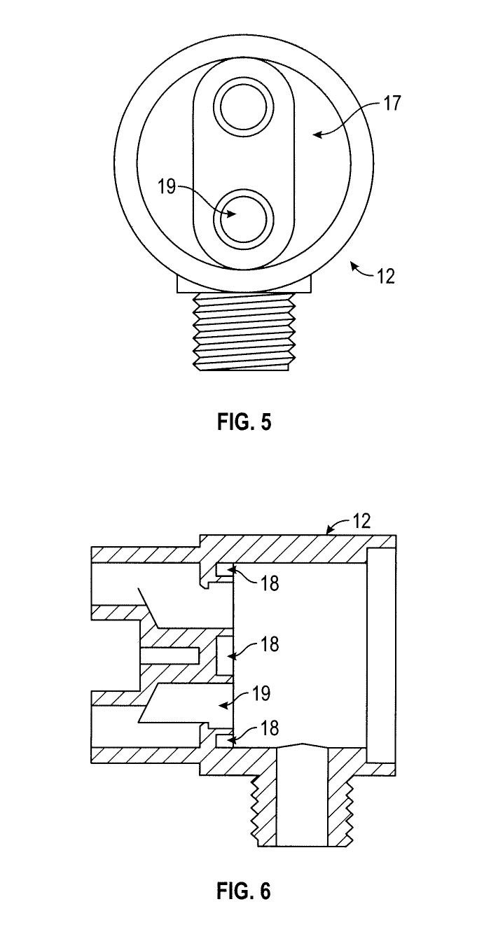

FIG. 5 and FIG. 6 respectively show the front view and the lateral view of the valve casing with an all-in-one two-hole seal gasket. The bottom along the inner wall of the valve casing 12 is provided with two valve casing channels 19; either of the valve casing channels 19 is communicated with the valve body channel 11; the valve casing 12 is also provided with a sealing mass gasket groove 18 simultaneously enclosing both the valve casing channels 19; in the seal gasket groove 18 is provided with a two-hole seal gasket 17 matched with the seal gasket groove 18; at least a part of the two-hole seal gasket 17 is exposed out of the seal gasket groove 18. Such a structure is available for providing a more reliable sealing effect.

What are mentioned above are only preferential embodiments of the utility model, not limiting the scope of protection of the utility model. Any substantially identical method available for realization of objectives of the utility model shall be within the scope of protection of the utility model.

1. The utility model relates to a valve with at least two active positions; when set at the first position, the valve can be connected to a first channel (13, 14); while set at the second position, the valve can be connected to a second channel (13, 15), in which, the valve constitutes a part of structure of a tyre repair kit (1) with a compression plant; the tyre repair kit (1) also comprises at least a cassette (2) with a sealing mass. The valve, serving as a rotary valve, once set at the first position, forms the first channel (13, 14) through which compressed air flows to an outlet (5), and once set at the second position, forms the second channel (13, 15) through which compressed air flows to the cassette (2) with a sealing mass. The utility model is characterized in that: the valve is provided with a cylindrical valve body (7); on the cylindrical surface of the valve body (7) is provided with a first ring groove(9); the first ring groove (9) is not only communicated with at least a valve body channel (11) extending lengthways along the cylindrical valve body (7), but also communicated with the outlet (5) to compressed air or the cassette (2) with a sealing mass; the valve is also provided with a valve casing (12) matched with the valve body (7); the bottom along the inner wall of the valve casing (12) is provided with two valve casing channels (19); either of the valve casing channels (19) is communicated with the valve body channel (11); the valve casing (12) is also provided with a sealing mass gasket groove (18) simultaneously enclosing the two valve casing channels (19); in the seal gasket groove (18) is provided with a two-hole seal gasket (17) matched with the seal gasket groove (18); at least a part of the two-hole seal gasket (17) is exposed out of the seal gasket groove (18).

2. The valve with at least two active positions of claim 1, wherein the valve body (7) can be manually revolved by an angle more than 45 degrees, preferably by an angle of 90 degrees or 180 degrees.

3. The valve with at least two active positions of claim 1, wherein the valve body (7) is subject to automatically mechanical rotation.

4. The valve with at least two active positions of claim 1, wherein on the outside surface of the cylindrical valve body (7) is provided with two second ring grooves (10) for the sealing rings (16); either of the sealing rings (16) sticks on the internal cylindrical surface of the valve casing (12).

5. The valve with at least two active positions of claim 1, wherein the two-hole seal gasket (17) is shaped like “8”.
